(19) United States
(12) Patent Application Publication
(10) Pub. No.: US 2009/0116682 A1
(43) Pub. Date: May 7, 2009

(54) Speaker and Method of Manufacturing the Same

(75) Inventors: Takashi Suzuki, Mie (JP); Shinya Mizone, Mie (JP); Masatoshi Okazaki, Hyogo (JP)

Correspondence Address: WENDEROTH, LIND & PONACK, L.L.P., 1030 15th Street, N.W.,, Suite 400 East, Washington, DC, 20005-1503, US

(73) Assignee: PANASONIC ELECTRONIC DEVICES CO., LTD., Osaka (JP)

(21) Appl. No.: 11/662,181

(22) PCT Filed: Nov. 14, 2005
(86) PCT No.: PCT/JP05/20795

§ 371 Date: Mar. 8, 2007

(30) Foreign Application Priority Data
Nov. 18, 2004 (JP) 2004-334123

(51) Int. Cl. H04R 1/00; H04R 31/00

(52) U.S. Cl. 381/412; 29/594

(57) ABSTRACT

Provided is a loudspeaker using a resin with adhesiveness as a surface treatment agent that has already been applied onto either of a diaphragm and a voice coil before bonding. Because this structure can reduce the weight of an adhesive agent used for bonding the diaphragm to the voice coil, a sound pressure level can be improved.

### TECHNICAL FIELD

The present invention relates to a loudspeaker including a diaphragm and a voice coil, and to a method of manufacturing the loudspeaker.

### BACKGROUND ART

Due to a common method of manufacturing a loudspeaker, a bobbin or a coil part of a voice coil is bonded to a diaphragm thereof with an adhesive applied thereto.

A description is provided of a loudspeaker formed by this manufacturing method with reference to FIG. 5. FIG. 5 is an exploded sectional view of a loudspeaker including bobbin 18a. First, magnet 11 is inserted between upper plate 12 and yoke 13 and bonded thereto, to form magnetic circuit 14 of the inner magnet type. Next, frame 16 is coupled with yoke 13 of magnetic circuit 14. Voice coil 18 is formed of hollow cylindrical bobbin 18a, and coil part 18b having a coil wound around the lower portion of the bobbin. Further, voice coil 18 is bonded to diaphragm 17 with adhesive 19, to form a vibrating system. Voice coil 18 is disposed into magnetic gap 15 in magnetic circuit 14. In this state, diaphragm 17 and frame 16 are bonded to each other with adhesive 20. An example of a loudspeaker manufactured in this manner is disclosed in Japanese Patent Unexamined Publication No. 2003-153386, for example.

FIG. 6 is an exploded sectional view of another loudspeaker that is smaller than the loudspeaker of FIG. 5. Elements similar to those in the loudspeaker of FIG. 5 are denoted with the same reference marks, and the detailed description of those elements is omitted. The loudspeaker of FIG. 6 is different from the loudspeaker of FIG. 5 in that voice coil 18c is only formed of a coil wound into a hollow cylindrical shape. The above conventional method of bonding diaphragm 17 to voice coil 18 or voice coil 18c with adhesive 19 has a problem that the weight increased by the weight of adhesive 19 decreases the sound pressure level.

### SUMMARY OF THE INVENTION

The present invention provides a loudspeaker including a diaphragm; a voice coil fixed to the diaphragm at one end thereof; and a magnetic circuit provided with a magnetic gap in which the other end of the voice coil is inserted. In the loudspeaker, the diaphragm and the one end of the voice coil are bonded by a surface treatment agent used for the diaphragm.

The present invention also provides a method of efficiently manufacturing the loudspeaker.

The loudspeaker of the present invention uses a resin having adhesiveness, as the surface treatment agent that has already been applied to the diaphragm or the voice coil before bonding. A part of the surface treatment agent is used as an adhesive. As a result, the thin and lightweight diaphragm and the voice coil can be bonded with a total weight of the adhesive smaller than that of the conventional loudspeaker. Thus, the sound pressure level and the mid-range and high-range threshold frequencies of the loudspeaker can be improved.

### BRIEF DESCRIPTION OF THE DRAWINGS

FIG. 1 is a sectional view of a loudspeaker in accordance with a first exemplary embodiment of the present invention.

FIG. 2A is a side elevational view illustrating a part of a method of manufacturing the loudspeaker shown in FIG. 1.

FIG. 2B is a side elevational view illustrating a part of the method of manufacturing the loudspeaker shown in FIG. 1.

FIG. 2C is a side elevational view illustrating a part of the method of manufacturing the loudspeaker shown in FIG. 1.

FIG. 2D is a side elevational view illustrating a part of the method of manufacturing the loudspeaker shown in FIG. 1.

FIG. 3 is a side elevational view illustrating a way of supplying a sheet of diaphragm in roll form.

FIG. 4 is a sectional view of a loudspeaker in accordance with a second exemplary embodiment of the present invention.

FIG. 5 is a sectional view illustrating a method of manufacturing a conventional loudspeaker.

FIG. 6 is a sectional view illustrating a method of manufacturing another conventional loudspeaker.

### REFERENCE MARKS IN THE DRAWINGS

1 Magnet

2 Upper plate

3 Yoke

4 Magnetic circuit

5 Magnetic gap

6 Frame

7 Sheet

7a Diaphragm

7b Diaphragm vertical wall

8 Voice coil

8a Bobbin

8b Coil part

8c Voice coil

9a Upper die

9b Lower die

9c Hole

### DETAILED DESCRIPTION OF PREFERRED EMBODIMENTS

Hereinafter, exemplary embodiments of the present invention are described with reference to the accompanying drawings. The drawings are schematic diagrams, and do not show the position of each element with the correct dimension. The present invention is not limited to each of the exemplary embodiments.

### First Exemplary Embodiment

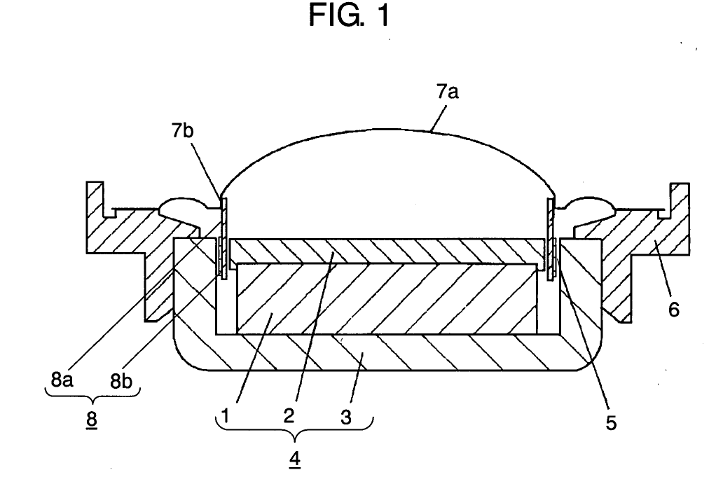

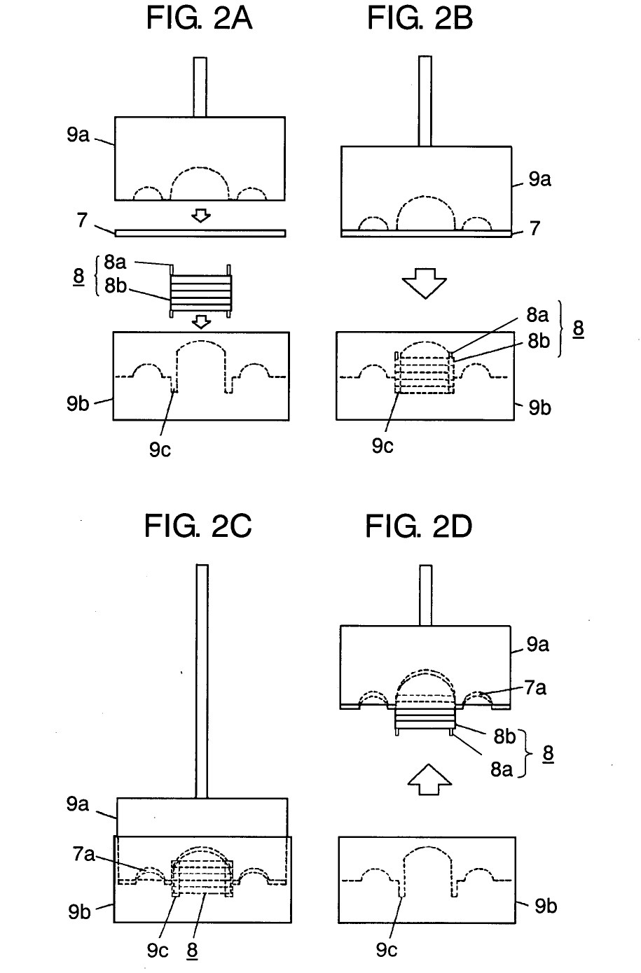

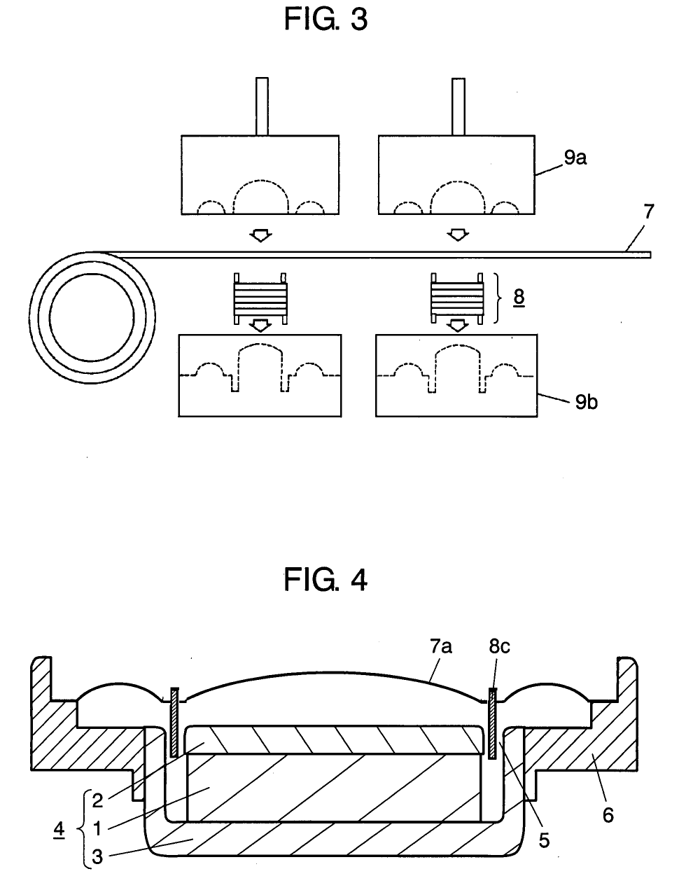

FIG. 1 is a sectional view of a loudspeaker in accordance with the present invention. FIGS. 2A through 2D are side elevational views illustrating the method of manufacturing a diaphragm and a voice coil in the method of manufacturing the loudspeaker in accordance with the present invention. FIG. 3 is a side elevational view illustrating a way supplying a sheet of diaphragm in roll form.

As shown in FIG. 1, diaphragm vertical wall 7b below the underside of dome-like cloth diaphragm 7a is bonded to the top end of bobbin 8a of voice coil 8, to form a vibrating system. The entire vibrating system is disposed so that the bottom end (coil part 8b) of voice coil 8 is inserted into magnetic gap 5 in magnetic circuit 4 that is made of magnet 1, upper plate 2, and yoke 3. In this state, the outer circumference of diaphragm 7a and frame 6 are bonded to each other.

FIGS. 2A and 2B illustrate the manufacture method of this vibrating system. First, as shown in FIG. 2A, upper die 9a goes down on sheet 7 for forming diaphragm 7a. At the same time, as shown in FIG. 2B, upper die 9a and sheet 7 are semi-joined to each other by air suction, heat, or static electricity. On the other hand, as shown in FIG. 2A, voice coil 8 is inserted into hole 9c in lower die 9b to make the state of FIG. 2B. Then, as shown in FIG. 2B, upper die 9a goes down on lower die 9b to make the state of FIG. 2C. At this time, heat forms sheet 7 into a diaphragm shape, and hardens filler (not shown) made of a thermosetting resin that has already been applied to cloth diaphragm 7a to fill up the air holes formed therethrough. In this manner, bonding bobbin 8a and diaphragm 7a integrates voice coil 8 and diaphragm 7a in these dies. Thereafter, upper die 9a having the vibrating system kept thereon leaves lower die 9b, and moves above the magnetic circuit (reference numeral “4” in FIG. 1) that has already been manufactured or is manufactured at the same time. Then, as shown in FIG. 1, the vibrating system is disposed so that the bottom end (coil part 8b) of voice coil 8 is inserted into magnetic gap 5 in magnetic circuit 4. In this state, the outer circumference of diaphragm 7a and frame 6 are joined with an adhesive or the like.

With the above-mentioned manufacturing method, diaphragm 7a and voice coil 8 can be bonded to each other with decreasing the quantity of adhesive used. As a result, the total weight of the vibrating system can be reduced. This reduction can improve the sound pressure level and mid-range and high-range threshold frequencies. Particularly for loudspeakers with small amplitude such as a tweeter and a micro speaker, in other words, a compact loudspeaker having a large weight ratio of the adhesive in the weight of the vibrating system, this method is considerably effective.

Other methods can be used in place of the method of semi-joining sheet 7 for forming diaphragm 7a to upper die 9a to move the sheet onto lower die 9b, as shown in FIG. 2A. For example, in the step of FIG. 2B, sheet 7 is placed to cover lower die 9b, and hot-pressed by upper die 9a onto the sheet.

Instead of these methods, supplying sheet 7 for forming diaphragm 7a from a roll can improve productivity as shown in FIG. 3.

The examples of filler made of thermosetting resin usable in the present embodiment include phenol resin, urea resin, alkyd resin, melamine resin, unsaturated polyester resin, and urethane resin.

In this exemplary embodiment, bonding operation using filler (not shown) in cloth diaphragm 7a is described as an example. Usable other than the example is any material with adhesiveness that has already been applied as a surface treatment agent of diaphragm 7a before bonding, such as a water repellant agent (not shown). Further, other than the thermosetting resin, materials with adhesiveness, such as thermoplastic resin, can be used.

When diaphragm 7a is made of a metal or a resin, a reinforcing agent (not shown) may be used to remove useless resonance and increase physical strength. A reinforcing agent (not shown) having adhesiveness, such as thermosetting resin, can provide the similar advantage. The examples of thermosetting resin usable in the present invention include phenol resin, urea resin, alkyd resin, melamine resin, unsaturated polyester resin, and urethane resin.

Further, using thermosetting resin as a water repellent agent (not shown) and a reinforcing agent (not shown) for bobbin 8a of voice coil 8 made of a kraft, a resin or a metal, to bond the bobbin to diaphragm 7a, can render higher adhesiveness. A thermosetting resin soluble in a solvent, such as an alcohol-reactivated resin, can also be used as a water repellent agent (not shown) and a reinforcing agent (not shown) for bobbin 8a of voice coil 8. Prior to the step shown in FIG. 2A, the resin may be softened by previously spraying a solvent such as an alcohol. Then, the resin may be hardened by the following hot press, and bonded to shaped diaphragm 7a.

The examples of thermosetting resin used as a reinforcing agent (not shown) or a water repellent agent (not shown) for bobbin 8a of voice coil 8 include phenol resin, urea resin, alkyd resin, melamine resin, unsaturated polyester resin, and urethane resin.

### Second Exemplary Embodiment

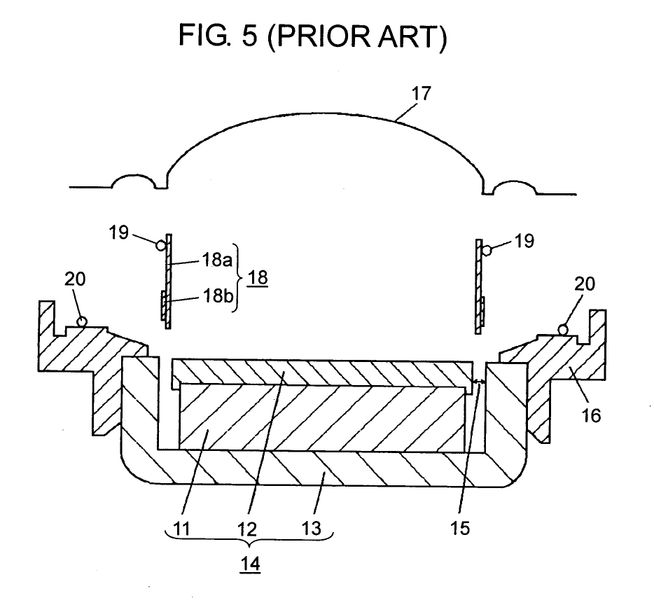

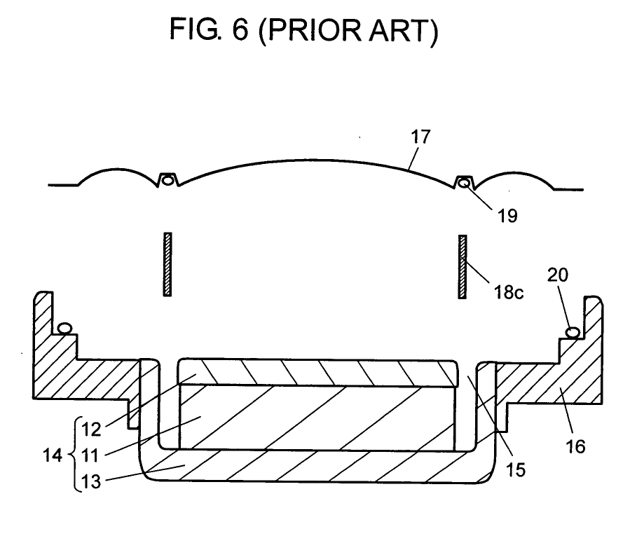

FIG. 4 shows a sectional view of a loudspeaker in accordance with the second exemplary embodiment of the present invention. For voice coil 8 of the first exemplary embodiment, coil part 8b is formed by winding a coil around bobbin 8a. In contrast, a coil is wound into a hollow coil shape without the use of bobbin 8a to form voice coil 8c in the present embodiment. In other words, the loudspeaker of the first exemplary embodiment corresponds to the conventional loudspeaker of FIG. 5, and the loudspeaker of the second exemplary embodiment corresponds to the conventional loudspeaker of FIG. 6.

Accordingly, as the loudspeaker of this exemplary embodiment includes no bobbin, the structure of the first exemplary embodiment without means of bonding bobbin 8a and diaphragm 7a can be used for this exemplary embodiment. Further, in this exemplary embodiment, voice coil 8c and diaphragm 7a are bonded to each other. For this reason, voice coil 8c and diaphragm 7a can be bonded by using a thermosetting resin for a fixing layer (not shown) of voice coil 8c.

The examples of the thermosetting resin for use in the fixing layer (not shown) of coil part 8b include polyethylene resin, polypropylene resin, vinyl chloride resin, polyvinylidene chloride resin, polystyrene resin, polyvinyl acetate resin, fluororesin, and urethane resin. The examples of solvent-soluble resin (not shown) used for bobbin 8a include polyurethane resin, polyamide resin, epoxy resin, and vinyl-based resin. When voice 8c is bonded to diaphragm 7a, a vertical wall can be provided along diaphragm 7a like the first exemplary embodiment so that the vertical wall is bonded to a part of the side surface of voice coil 8c to improve bonding strength. Meanwhile, the diaphragm shape in the present invention means a U shape used as a diaphragm of a loudspeaker. Further, the sheet is shaped like a roll or a flat plate in the exemplary embodiments of the present invention. However, a part of the diaphragm shape may be preformed previously.

### INDUSTRIAL APPLICABILITY

The present invention provides a loudspeaker in which a diaphragm and a voice coil thereof are bonded to each other with decreasing a quantity of adhesive used. Because the sound pressure and mid-range and high-range threshold frequencies of the loudspeaker can be improved, the loudspeaker can widely be used as those for portable telephones and automobiles.

1. A loudspeaker comprising:
a diaphragm;
a voice coil fixed to the diaphragm at one end thereof; and
a magnetic circuit provide with a magnetic gap, another end of the voice coil being disposed in the magnetic gap;
wherein the diaphragm and the one end of the voice coil are bonded by a surface treatment agent used for the diaphragm.

2. The loudspeaker according to claim 1, wherein the surface treatment agent is a resin-based filler for the diaphragm.

3. The loudspeaker according to claim 1, wherein the surface treatment agent is a resin-based water repellent agent for the diaphragm.

4. The loudspeaker according to claim 1, wherein the surface treatment agent is a resin-based reinforcing agent for the diaphragm.

5. The loudspeaker according to claim 1, wherein the voice coil includes a bobbin and a coil part disposed on the bobbin, the one end of the voice coil is one end of the bobbin, and the surface treatment agent is a resin-based water repellent agent for the bobbin.

6. The loudspeaker according to claim 1, wherein the voice coil includes a coil part and a resin-based fixing layer fixing the coil part, the one end of the voice coil is one end of the coil part, and the surface treatment agent is the resin-based fixing layer.

7. A method of manufacturing a loudspeaker comprising:
bringing a sheet into contact with one end of a voice coil;
forming the sheet into a diaphragm shape, and bonding the sheet to the voice coil at a same time; and
inserting another end of the voice coil into a magnetic gap in a magnetic circuit.

8. A method of manufacturing a loudspeaker comprising:
bringing a sheet into contact with one end of a voice coil;
forming the sheet into a diaphragm shape, and bonding the sheet to the voice coil when the sheet is hardened; and
inserting another end of the voice coil into a magnetic gap in a magnetic circuit.
